(19) United States
(12) Patent Application Publication
(10) Pub. No.: US 2019/0266403 A1
(43) Pub. Date: Aug. 29, 2019

(54) SERVER, METHOD AND WEARABLE DEVICE FOR SUPPORTING MAINTENANCE OF MILITARY APPARATUS BASED ON BINARY SEARCH TREE IN AUGMENTED REALITY-, VIRTUAL REALITY- OR MIXED REALITY-BASED GENERAL OBJECT RECOGNITION

(71) Applicant: FRONTIS CORP., Suwon-si (KR)

(72) Inventor: Jin Suk KANG, Suwon-si (KR)

(73) Assignee: FRONTIS CORP., Suwon-si (KR)

(21) Appl. No.: 16/212,682

(22) Filed: Dec. 7, 2018

Related U.S. Application Data
(63) Continuation of application No. PCT/KR2018/004481, filed on Apr. 18, 2018.

(30) Foreign Application Priority Data
Feb. 23, 2018 (KR) 10-2018-0021899
Mar. 13, 2018 (KR) 10-2018-0029154

(51) Int. Cl. G06K 9/00

(52) U.S. Cl. CPC G06K 9/00671; G06F 1/163

(57) ABSTRACT

The present disclosure provides a maintenance supporting server, including: an image receiving unit that receives an image of a military apparatus from a wearable device worn on the body of a maintenance mechanic; an object recognition unit that detects multiple maintenance objects from the image and recognizes at least one component object corresponding to at least one of the detected multiple maintenance objects; a maintenance target object extraction unit that extracts a maintenance target object based on distances between the recognized at least one component object and the respective maintenance objects; and a transmission unit that provides maintenance information of the extracted maintenance target object to the wearable device.

### TECHNICAL FIELD

The present disclosure relates to a server, a method and a wearable device for supporting the maintenance of a military apparatus based on augmented reality, virtual reality, or mixed reality.

### BACKGROUND

The general object recognition technology refers to a technology of recognizing the category of an object from an image by using various features of the object. Conventional object recognition technologies have typically estimated an object by using a color, a feature point, a pattern, etc. of the object.

However, as for military apparatuses, the same color and the same pattern are used on the outsides of the military apparatuses. Therefore, it has been difficult to apply the conventional object recognition technologies to the military apparatuses.

Meanwhile, a head-mounted display (HMD) is a display device worn on the head and refers to a next-generation display device that enables a user who wears the HMD on the head to directly watch images before his/her eyes. The HMD usually displays a virtual image or virtual UI overlaid on the real world.

As one of the prior arts relevant to the HMD, Korean Patent Laid-open Publication No. 2009-0105485 discloses a multi-media offering system using a HMD and an offering method thereof.

In recent years, a service for supporting the maintenance of a military apparatus by using a HMD has been provided. However, the maintenance of a military apparatus by using a HMD requires a lot of time to analyze recognition rate, performance, or the like during object recognition due to characteristic military colors and similar-sized components of the military apparatus. Accordingly, a real-time service for transferring a recognition result for the recognized maintenance objects and component objects may be delayed.

### SUMMARY

In view of the foregoing, the present disclosure provides an augmented reality (AR)-based server, method and wearable device for supporting the maintenance of a military apparatus that facilitate the support of maintenance in a virtual environment and the management of a maintenance education system by recognizing a component object for the maintenance of the military apparatus and extracting a maintenance target object.

The present disclosure provides a server, a method and a wearable device for supporting the maintenance of a military apparatus that facilitate the support of a preemptive service by predicting a maintenance target object of the military apparatus and probabilistically deriving relative mobile characteristics.

It has been difficult to efficiently manage and classify data based on texture form or document with the existing interactive electronic technical manual (IETM). Therefore, the present disclosure provides a server, a method and a wearable device for supporting the maintenance of a military apparatus that enable effective management of this by using multimedia data such as virtual reality (VR), augmented reality (AR), mixed reality (MR), etc.

The present disclosure provides a server, a method and a wearable device for supporting the maintenance of a military apparatus that improve the degree of understanding of a maintenance mechanic in manipulation and maintenance of the military apparatus and thus facilitate the support of maintenance.

The present disclosure provides a server, a method and a wearable device for supporting the maintenance of a military apparatus that provide case-based maintenance information through a three-dimensional screen of a wearable device to provide a maintenance mechanic with convenience in performing the maintenance of the military apparatus.

The present disclosure provides a server, a method and a wearable device for supporting the maintenance of a military apparatus that increase the benefit of maintenance by preventing accidents and predicting malfunctions in the machinery maintenance industry such as the maintenance of a military apparatus.

The present disclosure provides a server, a method and a wearable device for supporting the maintenance of a military apparatus that can build up an infrastructure for generally managing the maintenance support and the maintenance education for the military apparatus by applying MR technology through interworking of sensor data about maintenance details of the military apparatus and component information with location-based technology.

However, problems to be solved by the present disclosure are not limited to the above-described problems. There may be other problems to be solved by the present disclosure.

According to an aspect of the present disclosure, a maintenance supporting server includes: an image receiving unit that receives an image of a military apparatus from a wearable device worn on the body of a maintenance mechanic; an object recognition unit that detects multiple maintenance objects from the image and recognizes at least one component object corresponding to at least one of the detected multiple maintenance objects; a maintenance target object extraction unit that extracts a maintenance target object based on distances between the recognized at least one component object and the respective maintenance objects; and a transmission unit that provides maintenance information of the extracted maintenance target object to the wearable device.

According to another aspect of the present disclosure, a method for supporting maintenance includes: receiving an image of a military apparatus from a wearable device worn on the body of a maintenance mechanic; detecting multiple maintenance objects from the image and recognizing at least one component object corresponding to at least one of the detected multiple maintenance objects; extracting a maintenance target object based on distances between the recognized at least one component object and the respective maintenance objects; and providing maintenance information of the extracted maintenance target object to the wearable device.

According to yet another aspect of the present disclosure, a wearable device includes: a photographing unit that photographs a military apparatus with a camera provided in the wearable device; a transmission unit that transmits a photographed image of the military apparatus to a maintenance supporting server; a receiving unit that receives maintenance information of a maintenance target object of the military apparatus from the maintenance supporting server; and a display unit that displays the received maintenance information of the maintenance target object on a display. Herein, the maintenance supporting server detects multiple maintenance objects from the image and recognizes at least one component object corresponding to at least one of the detected multiple maintenance objects, and the maintenance target object is extracted based on distances between the recognized at least one component object and the respective maintenance objects.

The above-described aspects are provided by way of illustration only and should not be construed as liming the present disclosure. Besides the above-described embodiments, there may be additional embodiments described in the accompanying drawings and the detailed description.

According to the present disclosure, it is possible to provide an augmented reality (AR)-based server, method and wearable device for supporting the maintenance of a military apparatus that facilitate the support of maintenance in a virtual environment and the management of a maintenance education system by recognizing a component object for the maintenance of the military apparatus and extracting a maintenance target object.

Further, according to the present disclosure, it is possible to provide a server, a method and a wearable device for supporting the maintenance of a military apparatus that facilitate the support of a preemptive service by predicting a maintenance target object of the military apparatus and probabilistically deriving relative mobile characteristics.

It has been difficult to efficiently manage and classify data based on texture form or document with the existing interactive electronic technical manual (IETM). Therefore, according to the present disclosure, it is possible to provide a server, a method and a wearable device for supporting the maintenance of a military apparatus that enable effective management of this by using multimedia data such as virtual reality (VR), augmented reality (AR), mixed reality (MR), etc.

Furthermore, according to the present disclosure, it is possible to provide a server, a method and a wearable device for supporting the maintenance of a military apparatus that improve the degree of understanding of a maintenance mechanic in manipulation and maintenance of the military apparatus and thus facilitate the support of maintenance.

Moreover, according to the present disclosure, it is possible to provide a server, a method and a wearable device for supporting the maintenance of a military apparatus that provide case-based maintenance information through a three-dimensional screen of a wearable device to provide a maintenance mechanic with convenience in performing the maintenance of the military apparatus.

Besides, according to the present disclosure, it is possible to provide a server, a method and a wearable device for supporting the maintenance of a military apparatus that increase the benefit of maintenance by preventing accidents and predicting malfunctions in the machinery maintenance industry such as the maintenance of a military apparatus.

Further, according to the present disclosure, it is possible to provide a server, a method and a wearable device for supporting the maintenance of a military apparatus that can build up an infrastructure for generally managing the maintenance support and the maintenance education for the military apparatus by applying MR technology through interworking of sensor data about maintenance details of the military apparatus and component information with location-based technology.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is an example diagram illustrating a system for supporting the maintenance of a military apparatus in accordance with various embodiments described herein.

FIG. 2 is a configuration view of a wearable device in accordance with various embodiments described herein.

FIG. 3 is an example diagram provided to explain a process of displaying maintenance information of a maintenance target object on a display in a wearable device in accordance with various embodiments described herein.

FIG. 4 is a flowchart showing a method for receiving the maintenance support for a military apparatus by a wearable device in accordance with various embodiments described herein.

FIG. 5 is a configuration view of a maintenance supporting server in accordance with various embodiments described herein.

FIG. 6A and FIG. 6B are example diagrams provided to explain a process of supporting the maintenance of a military apparatus in accordance with various embodiments described herein.

FIG. 7 is an example diagram provided to explain a process of determining a maintenance target object by applying information about distances between a recognized component object and respective maintenance objects to a case-based inference algorithm in accordance with various embodiments described herein.

FIG. 8A and FIG. 8B are example diagrams provided to explain a process of determining a maintenance target object based on a case classification tree created on the basis of information about distances between a component object and respective maintenance objects and a similarity table in accordance with various embodiments described herein.

FIG. 9 is a flowchart showing a method for supporting the maintenance of a military apparatus by a maintenance supporting server in accordance with various embodiments described herein.

### DETAILED DESCRIPTION

Hereinafter, embodiments of the present disclosure will be described in detail with reference to the accompanying drawings so that the present disclosure may be readily implemented by a person with ordinary skill in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, it is to be understood that the term “comprises or includes” and/or “comprising or including” used in the document means that one or more other components, steps, operation and/or existence or addition of elements are not excluded in addition to the described components, steps, operation and/or elements unless context dictates otherwise and is not intended to preclude the possibility that one or more other features, numbers, steps, operations, components, parts, or combinations thereof may exist or may be added.

Through the whole document, the term “unit” includes a unit implemented by hardware, a unit implemented by software, and a unit implemented by both of them. One unit may be implemented by two or more pieces of hardware, and two or more units may be implemented by one piece of hardware.

Through the whole document, a part of an operation or function described as being carried out by a device or apparatus may be carried out by a server connected to the device or apparatus. Likewise, a part of an operation or function described as being carried out by a server may be carried out by a device or apparatus connected to the server.

Hereinafter, embodiments of the present disclosure will be described in detail with reference to the accompanying drawings.

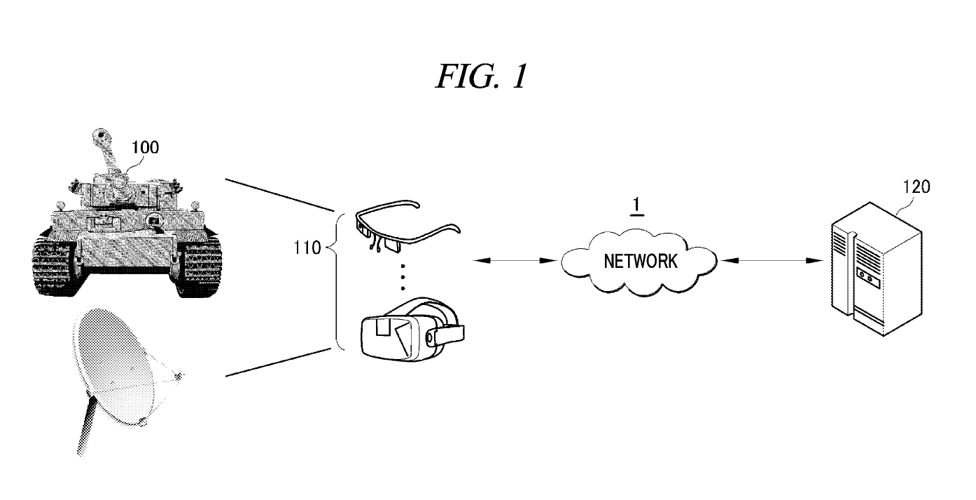

FIG. 1 is an example diagram illustrating a system for supporting the maintenance of a military apparatus in accordance with various embodiments described herein. Referring to FIG. 1, a system 1 for supporting the maintenance of a military apparatus may include a wearable device 110 and a maintenance supporting server 120. The wearable device 110 and the maintenance supporting server 120 are illustrated as examples of the components which can be controlled by the system 1 for supporting the maintenance of a military apparatus.

The components of the system 1 for supporting the maintenance of a military apparatus illustrated in FIG. 1 are typically connected to each other via a network. For example, as illustrated in FIG. 1, the wearable device 110 may be connected to the maintenance supporting server 120 simultaneously or sequentially.

The term “network” refers to a connection structure that enables information exchange between nodes such as devices, servers, etc. and includes LAN (Local Area Network), WAN (Wide Area Network), Internet (WWW: World Wide Web), a wired or wireless data communication network, a telecommunication network, a wired or wireless television network, and the like. Examples of the wireless data communication network may include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, VLC (Visible Light Communication), LiFi, and the like, but may not be limited thereto.

The wearable device 110 may photograph a military apparatus 100 with a camera provided in the wearable device 110.

The wearable device 110 may transmit a photographed image of the military apparatus 100 to the maintenance supporting server 120.

The wearable device 110 may receive maintenance information of a maintenance target object of the military apparatus 100 from the maintenance supporting server 120. For example, the wearable device 110 may receive the maintenance information in the form of augmented reality (AR), virtual reality (VR), or mixed reality (MR) from the maintenance supporting server 120. The maintenance information may include, for example, maintenance details of the maintenance target object, maintenance guide information for the maintenance target object, a list of component objects used for the maintenance of maintenance objects, etc.

The wearable device 110 may display the received maintenance information of the maintenance target object on a display. For example, the wearable device 110 may display the maintenance information in the form of AR, VR, or MR in each of multiple output areas.

Examples of the wearable device 110 may include a HoloLens, a smart glass, a head-mounted display (HMD), or a head-up display (HUD) which can be worn on the body of a maintenance mechanic.

The maintenance supporting server 120 may include a database including information relevant to the maintenance of the military apparatus, maintenance history information, similarity information between maintenance-related tasks and detailed work items, and feedback information of a determined maintenance target object input by the maintenance mechanic.

This is to enable the maintenance mechanic to recall the military apparatus 100 showing similar signs based on the analysis of a previous maintenance pattern and repair the military apparatus 100 and solve repeatedly occurring problems by imitating or coping the solutions thereto.

The maintenance supporting server 120 may receive the image of the military apparatus 100 from the wearable device 110 worn on the body of the maintenance mechanic.

The maintenance supporting server 120 may detect multiple maintenance objects from the image and recognize at least one component object corresponding to at least one of the detected multiple maintenance objects. For example, the maintenance supporting server 120 may segment a frame of the image into multiple cells and extract an edge of at least one component object by applying a location of the extracted at least one component object to a cell of the frame of the image.

The maintenance supporting server 120 may extract pixels from the recognized at least one component object. In this case, the maintenance supporting server 120 may cluster the extracted at least one pixel into similar pixel groups.

The maintenance supporting server 120 may extract a maintenance target object based on distances between the recognized at least one component object and the respective maintenance objects. For example, the maintenance supporting server 120 may extract the clustered similar pixel groups as multiple candidate maintenance areas and extract a maintenance area including a maintenance target object from among the extracted multiple candidate maintenance areas by using distances between at least one component object and respective maintenance target objects.

The maintenance supporting server 120 may measure the distances between the recognized at least one component object and the respective maintenance objects. The maintenance supporting server 120 may extract a maintenance object which the at least one component object is approaching as the maintenance target object, recognize at least one component object included in the maintenance target object, and extract a location of the recognized component object.

The maintenance supporting server 120 may determine, from the image, an approach state of each of at least one component object being moved by the maintenance mechanic to a maintenance object. For example, the maintenance supporting server 120 may extract a maintenance target object based on an approach state of each of at least one component object to a maintenance object during a first unit time and an approach state of each of at least one component object to a maintenance object during a second unit time after the first unit time. In this case, the maintenance supporting server 120 may classify each maintenance object as a first maintenance area or a second maintenance area based on the approach state of each of at least one component object to a maintenance object during the first unit time and the approach state of each of at least one component object to a maintenance object during the second unit time after the first unit time and extract a maintenance object corresponding to the first maintenance area as a maintenance target object. Herein, the first maintenance area may include a maintenance object to which maintenance is to be performed and the second maintenance area may include a maintenance object to which maintenance is not to be performed.

The maintenance supporting server 120 may determine at least one maintenance target object from among multiple maintenance objects detected by applying information about the distances between the recognized at least one component object and the respective maintenance objects to a case-based inference algorithm. Herein, the case-based inference algorithm includes a similarity table based on an approach state between a component object and a maintenance object, and the maintenance supporting server 120 may create a case classification tree based on the information about the distances between the recognized at least one component object and the respective maintenance objects and the similarity table and determine at least one maintenance target object based on the created case classification tree.

The maintenance supporting server 120 may transmit maintenance information of the extracted maintenance target object to the wearable device 110. For example, the maintenance supporting server 120 may transmit the maintenance information in the form of AR, VR, or MR to the wearable device 110. The maintenance information may include, for example, maintenance details of the maintenance target object, maintenance guide information for the maintenance target object, a list of component objects used for the maintenance of maintenance objects, etc.

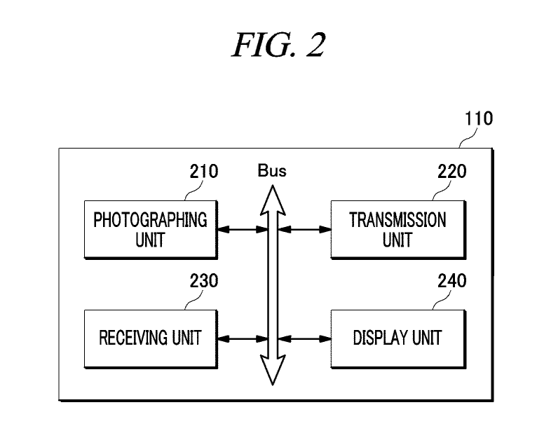

FIG. 2 is a configuration view of a wearable device in accordance with various embodiments described herein. Referring to FIG. 1 and FIG. 2, the wearable device 110 may include a photographing unit 210, a transmission unit 220, a receiving unit 230, and a display unit 240.

The photographing unit 210 may photograph the military apparatus 100 with the camera provided in the wearable device 110.

The transmission unit 220 may transmit a photographed image of the military apparatus 100 to the maintenance supporting server 120. For example, the transmission unit 220 may transmit a hololens image of the military apparatus 100 to the maintenance supporting server 120.

The receiving unit 230 may receive maintenance information of a maintenance target object of the military apparatus 100 from the maintenance supporting server 120. For example, the receiving unit 230 may receive the maintenance information in the form of AR, VR, or MR from the maintenance supporting server 120. The maintenance information may include, for example, maintenance details of the maintenance target object, maintenance guide information for the maintenance target object, a list of component objects used for the maintenance of maintenance objects, etc.

The display unit 240 may display the received maintenance information of the maintenance target object on a display. For example, the display unit 240 may display the maintenance information in the form of AR, VR, or MR in each of multiple output areas of the wearable device 110.

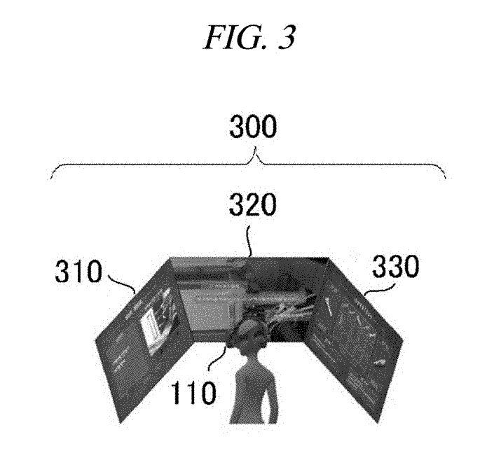

FIG. 3 is an example diagram provided to explain a process of displaying maintenance information of a maintenance target object on a display in a wearable device in accordance with various embodiments described herein. Referring to FIG. 3, the wearable device 110 may display maintenance information of a maintenance target object on a display 300.

For example, the wearable device 110 may display maintenance guide information for the maintenance target object in the form of VR in a first area 310 of the display 300.

The wearable device 110 may display a maintenance guide video or a maintenance manual with voice/image/text support for the maintenance target object in the form of VR for the maintenance mechanic in the first area 310 of the display 300.

For another example, the wearable device 110 may display maintenance details of the maintenance target object in the form of AR in the first area 310 of the display 300.

The wearable device 110 may output AR-, VR- or MR-based images for supporting maintenance in a second area 320 of the display 300.

For example, the wearable device 110 may display a nearest-neighbor distance to apply the maintenance object recognition technique using case-based inference for maintenance cases and thus facilitate a marker-less approach to a maintenance target object and a component in the maintenance details and support maintenance.

For another example, the wearable device 110 may display a maintenance tool box (including component objects and information thereof) in a third area 330 of the display 300. The wearable device 110 may display, in the third area 330 of the display 300, components required for the extracted maintenance target object and components which can be selected by the maintenance mechanic and may provide an interaction matrix relevant to the maintenance support.

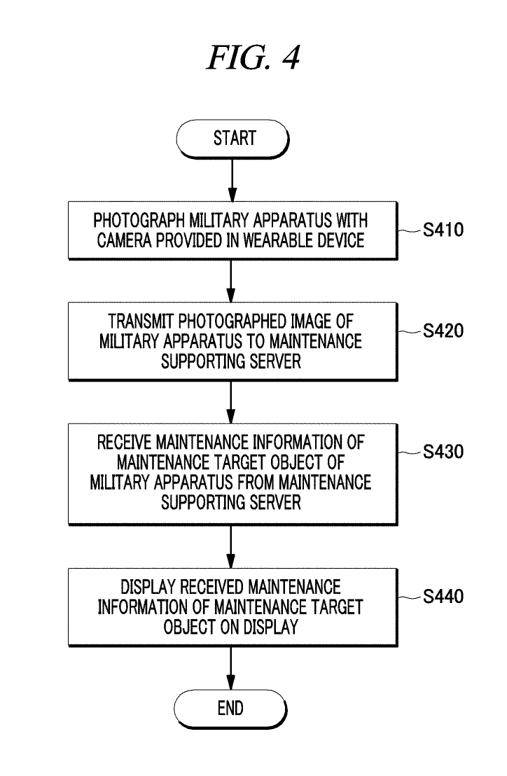

FIG. 4 is a flowchart showing a method for receiving the maintenance support for a military apparatus by a wearable device in accordance with various embodiments described herein. A method for receiving the maintenance support for the military apparatus 100 by the wearable device 110 illustrated in FIG. 4 includes the processes time-sequentially performed by the system 1 for supporting the maintenance of a military apparatus according to the embodiment illustrated in FIG. 1 to FIG. 3. Therefore, descriptions of the processes performed by the system 1 for supporting the maintenance of a military apparatus may be applied to the method for receiving the maintenance support for the military apparatus 100 by the wearable device 110 according to the embodiment illustrated in FIG. 1 to FIG. 3, even though they are omitted hereinafter.

In a process 5410, the wearable device 110 may photograph the military apparatus 100 with the camera provided in the wearable device 110.

In a process 5420, the wearable device 110 may transmit a photographed image of the military apparatus 100 to the maintenance supporting server 120.

In a process 5430, the wearable device 110 may receive maintenance information of a maintenance target object of the military apparatus 100 from the maintenance supporting server 120. For example, the wearable device 110 may receive the maintenance information in the form of AR, VR, or MR from the maintenance supporting server 120. Herein, the maintenance information may include, for example, maintenance details of the maintenance target object, maintenance guide information for the maintenance target object, a list of component objects used for the maintenance of maintenance objects, etc.

In a process 5440, the wearable device 110 may display the received maintenance information of the maintenance target object on a display.

In the descriptions above, the processes 5410 to 5440 may be divided into additional processes or combined into fewer processes depending on an embodiment. In addition, some of the processes may be omitted and the sequence of the processes may be changed if necessary.

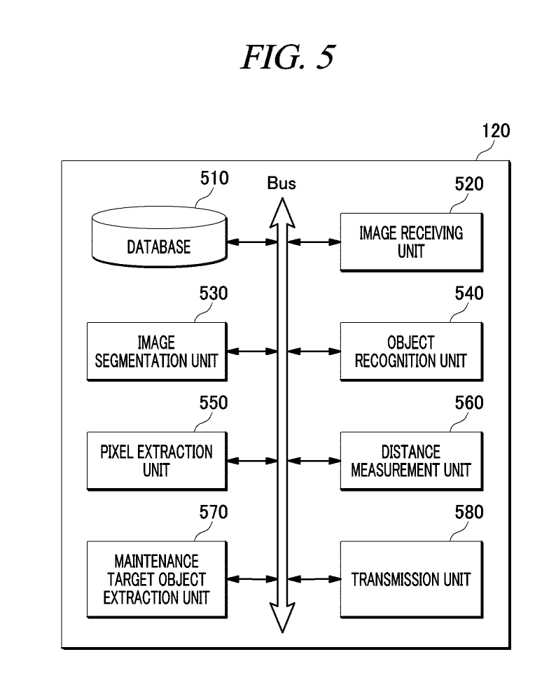

FIG. 5 is a configuration view of a maintenance supporting server in accordance with various embodiments described herein. Referring to FIG. 1 and FIG. 5, the maintenance supporting server 120 may include a database 510, an image receiving unit 520, an image segmentation unit 530, an object recognition unit 540, a pixel extraction unit 550, a distance measurement unit 560, a maintenance target object extraction unit 570, and a transmission unit 580.

The database 510 may include information relevant to the maintenance of the military apparatus, maintenance history information, similarity information between maintenance-related tasks and detailed work items, and feedback information of a determined maintenance target object received from the wearable device 110.

The information relevant to the maintenance of the military apparatus 100 refers to working knowledge which is more practical than general knowledge of a corresponding task, and may provide knowhow, methods, experiences accumulated in various situations with understanding of problems in the respective situations and knowledge capable of solving the problems.

The maintenance history information refers to records of all the various tasks relevant to the maintenance of the military apparatus 100, and key information of each record may be stored in the form of metadata. The records may include, for example, digital data, paper reports, books, minutes, work logs, memos, notes, etc.

The similarity information refers to the similarity between a task found by maintenance-relevant job analysis and detailed work items, and initial scores in the similarity table are arranged from the lowest to the highest depending on the degree of relationship between the items and set to be assigned when the compared items are the same.

As for the feedback information, the existing values in the similarity table may continuously and automatically evolve from the initial values by providing, by the maintenance mechanic, feedback on a recommended case (including a determined maintenance target object and maintenance information thereof) with respect to provided knowledge. Herein, the feedback may refer to the maintenance mechanic's determination/evaluation on how helpful original data for the recommended case are in solving a problem.

As such, problems occurring during maintenance and maintenance situations or knowledge acquired from experiences are stored in the database 510. Therefore, when any problem arises, information relevant to a corresponding situation with a solution thereto can be provided. Further, a similar problem or case may be retrieved from previous similar experiences. Thus, it is possible to find a clue to solve the present problem from the case or possible to use the case as a reference for determination.

Further, empirical cases acquired from an expert or manager may be accumulated, and if any new determination (decision) is needed, cases similar to the present problem are retrieved from various empirical cases stored in the database 510 and compared and analyzed to more easily solve the present problem.

The image receiving unit 520 may receive an image of the military apparatus 100 from the wearable device 110 worn on the body of the maintenance mechanic. For example, the image receiving unit 520 may receive a hololens image of the military apparatus 100 from the wearable device 110 worn on the body of the maintenance mechanic.

The image segmentation unit 530 may segment a frame of the image into multiple cells. The frame of the image is segmented into the multiple cells to detect an object and edges (lines, curves, etc.) and thus to simplify or convert the expression of the image into a more meaningful and easy-to-interpret one. In order for the wearable device 110 to recognize an object, objects such as an object and a target object in a digital image (2D), a video, and a real image need to be classified according to general categories and grouped into multiple groups in a frame. The result of segmenting a frame of the image into multiple cells may be a group of sections collectively including the whole image or a group of outlines extracted from the image. Pixels in a section are similar to each other in terms of certain features such as color, brightness, and material or calculated attributes, and neighboring sections may be significantly different from each other in the same features.

The object recognition unit 540 may detect multiple maintenance objects from the image and recognize at least one component object corresponding to at least one of the detected multiple maintenance objects.

The object recognition unit 540 may recognize at least one component object included in a maintenance target object and extract a location of the recognized component object. For example, the object recognition unit 540 may detect an edge of the at least one component object by applying the extracted location of the at least one component object to a cell of a frame of the image.

The pixel extraction unit 550 may extract pixels from the recognized at least one component object. In this case, the pixel extraction unit 550 may cluster the extracted at least one pixel into similar pixel groups. For example, the pixel extraction unit 550 may use the k-means method to extract pixels from the recognized component object and cluster the pixels into similar pixel groups. The reason for clustering is that a feature and a state for each location of the recognized component object are needed and there may be a difference in the number of feature and state and accuracy in prediction depending on the size of a location unit. Therefore, the number of clusters may be determined by anticipating that pixels are previously clustered in a parallel manner regardless of the hierarchy of clusters, and, thus, partial clustering can be achieved.

The distance measurement unit 560 may measure distances between the recognized at least one component object and the respective maintenance objects.

The distance measurement unit 560 may determine, from the image, an approach state of each of at least one component object being moved by the maintenance mechanic to a maintenance object. Herein, the approach state refers to a distance between maintenance objects of the military apparatus 100 and a variation depending on distance and time. The distance measurement unit 560 may derive a relative approach state of each component object to a maintenance object.

For example, the distance measurement unit 560 may determine an approach state of each component object to a maintenance object as any one of Neutral, Inward, and Outward. Neutral refers to a state in which a maintenance object is not detected from an image, Inward refers to a state in which a component object detected from an image approaches a maintenance object, and Outward refers to a state in which a component object in an image moves away from a maintenance component. It is possible to reduce resources required for operation and storage of approach states by using these three state values. In this case, a mobility state value at the immediately preceding point in time and a mobility state value at the current point in time are considered, and, thus, variables indicating various state transitions can be diversified.

For example, [Neutral, Inward] or [Outward, Inward] indicating a preceding indirect element mobile characteristic (a mobility state value at the preceding point in time) and a current indirect element mobile characteristic (a mobility state value at the current point in time) may represent a relative approach state in which a component object in a coverage area from the military apparatus 100 moves away from a maintenance component and gets closer to the maintenance object over time.

Herein, the distance unit for determining an approach state may vary depending on an object recognition method and a measurement device. For example, a measurable range for recognizing an object in a hololens image may employ a distance based on a specific length unit such as m or cm and a distance between component objects in a maintenance object can be used as a reference. In this case, the distance measurement unit 560 may derive a relative approach state between a maintenance object and a component object for all of maintenance items.

The reason for determining an approach state is that maintenance objects and component objects may be fixed or movable due to the characteristics of the of the military apparatus 100 and the determination of an approach state can be applied when a relative approach state of maintenance object and a component object changes as the wearable device 110 moves.

The distance measurement unit 560 may derive an approach state between a maintenance object and a component object by periodic monitoring and event notification (e.g., in the form of hover help) with text support in an AR screen.

According to the event notification, it is possible to determine an approach state by detecting when a maintenance object and a component object of the military apparatus 100 are within a predetermined range and it is possible to notify of an event to be processed in a distributed environment or it possible to notify of an event to be processed in a centralized environment via an IEEE 802.12ac wireless network. Further, it is also possible to notify of information about change when a variation in relative distance between maintenance objects exceeds a predetermined reference level.

According to the periodic monitoring, it is possible to detect and recognize a change of a component object at predetermined time intervals and periodic relative approach states can be shared with neighboring nodes or a central processing system.

The maintenance target object extraction unit 570 may extract a maintenance target object based on the distances between the recognized at least one component object and the respective maintenance objects. The maintenance target object extraction unit 570 may extract the clustered similar pixel groups as multiple candidate maintenance areas and extract a maintenance area including a maintenance target object from among the extracted multiple candidate maintenance areas by using the distances between the at least one component object and the respective maintenance target objects.

The maintenance target object extraction unit 570 may extract a maintenance object which the at least one component object is approaching as the maintenance target object.

The maintenance target object extraction unit 570 may extract a maintenance target object based on an approach state of each of at least one component object to a maintenance object during a first unit time (preceding point in time) and an approach state of each of at least one component object to a maintenance object during a second unit time (current point in time) after the first unit time.

The maintenance target object extraction unit 570 may classify each maintenance object as a first maintenance area or a second maintenance area based on the approach state of each of at least one component object to a maintenance object during the first unit time and the approach state of each of at least one component object to a maintenance object during the second unit time after the first unit time and extract a maintenance object corresponding to the first maintenance area as a maintenance target object. Herein, the first maintenance area may include a maintenance object to which maintenance is to be performed and the second maintenance area may include a maintenance object to which maintenance is not to be performed.

Approach states of component objects to a maintenance object can be classified into eight types. Herein, approach states of component objects to a maintenance object can be actually classified into nine types. However, the possibility that the mobility state has a state transition value of [N, O] is very low, and, thus, there may be eight state transitions.

A state transition may be represented by an index formula indicating a mobility state transition in an eight-state set S, such as (a mobility state value at the preceding point in time, a mobility state value at the current point in time)=(N, N).

That is, a mobility state transition at the subsequent point in time can be represented by using k number of mobility state values at the preceding point in time and the current point in time during a period from time t−k+1 to time t. herein, the set S can be represented as S={(N, N), (N, I), (I, I), (I, O), (I, N), (O, I), (O, O), (O, N)}.

Herein, the first maintenance area refers to a positive maintenance area to which maintenance can be performed or needs to be performed and the second maintenance area refers to a negative maintenance area to which maintenance cannot be performed or does not need to be performed.

Herein, the positive maintenance area may include a maintenance object which is in need of maintenance based on maintenance history of each of the recognized multiple maintenance objects. Further, the positive maintenance area may include a maintenance object compatible with a recognized maintenance component. Furthermore, the positive maintenance area may include a maintenance object in which a recognized maintenance component needs to be replaced.

The negative maintenance area may include a maintenance object which is not in need of maintenance based on maintenance history of each of the recognized multiple maintenance objects. Further, the negative maintenance area may include a maintenance object incompatible with a recognized maintenance component. Furthermore, the negative maintenance area may include a maintenance object in which a recognized maintenance component does not need to be replaced.

The maintenance target object extraction unit 570 may determine at least one maintenance target object from among multiple maintenance objects detected by applying information about the distances between the recognized at least one component object and the respective maintenance objects to a case-based inference algorithm.

Herein, the case-based inference algorithm includes a similarity table based on an approach state between a component object and a maintenance object. For example, the maintenance target object extraction unit 570 may create a case classification tree based on the information about the distances between the recognized at least one component object and the respective maintenance objects and the similarity table and determine at least one maintenance target object based on the created case classification tree.

The similarity table may be configured including, for example, (O, I) and (I, I) as a first case, (N, N) and (I, O) as a second case, (N, I) and (I, N) as a third case, and (O, N) and (O, O) as a fourth case based on approach states between a component object and respective maintenance objects.

The transmission unit 580 may provide maintenance information of the extracted maintenance target object to the wearable device 110. For example, the transmission unit 580 may provide the maintenance information in the form of AR, VR, or MR to the wearable device 110. The maintenance information may include, for example, maintenance details of the maintenance target object, maintenance guide information for the maintenance target object, a list of component objects used for the maintenance of maintenance objects, etc.

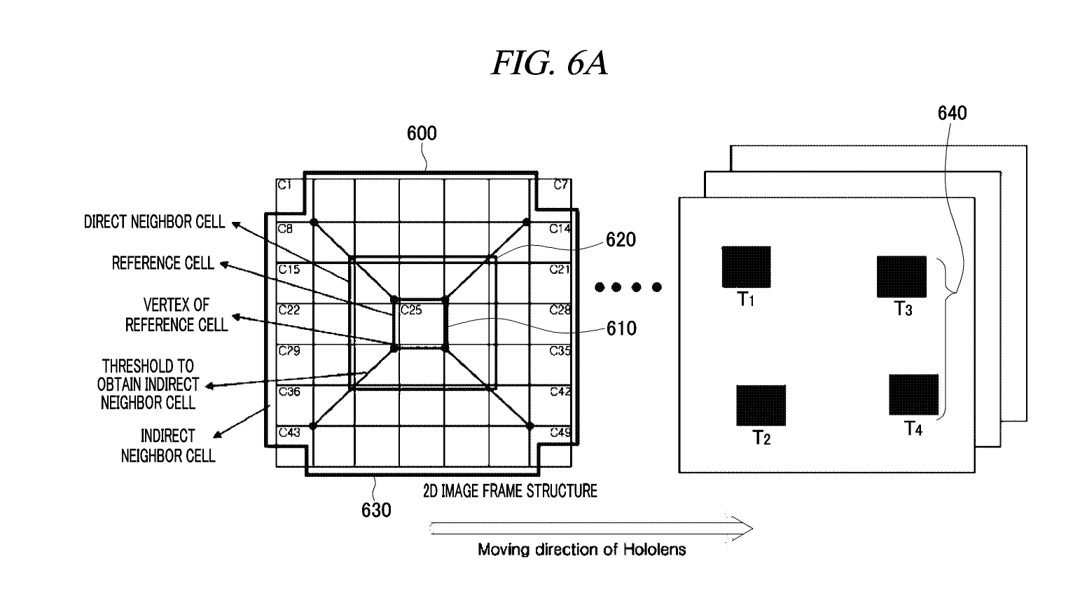

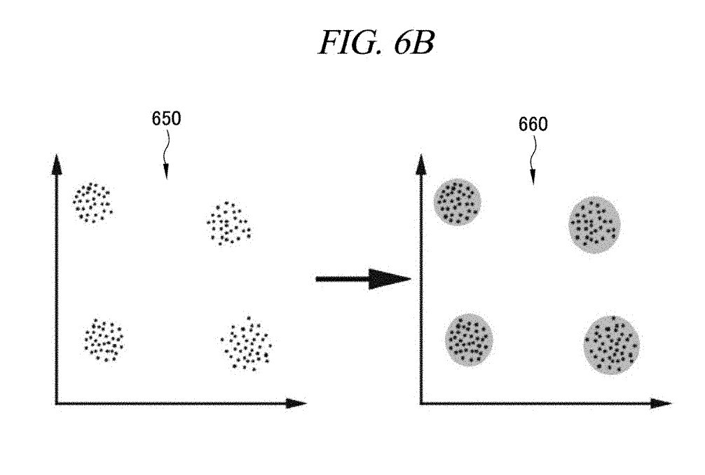

FIG. 6A and FIG. 6B are example diagrams provided to explain a process of supporting the maintenance of a military apparatus in accordance with various embodiments described herein.

FIG. 6A is an example diagram provided to explain a process of recognizing a component object in accordance with various embodiments described herein. Referring to FIG. 6A, the maintenance supporting server 120 may recognize a component object included in a maintenance target object, extract a location of the recognized component object, and apply the extracted location of the component object to a cell of a 2D image frame 600 segmented into multiple cells to detect an edge of the component object. The 2D image frame 600 may be configured to be equally segmented into the smallest unit cells, and the edge of the component object can be detected by applying the location of the component object to a reference cell 610 of the image frame. Further, a direct cell 620 and an indirect cell 630 may be derived from the reference cell 610 to determine an approach state of the component object to a maintenance object. An approach state of the frame may be set to include the size and direction of the maintenance object by applying the k-means method.

For example, the maintenance supporting server 120 may determine approach states of component objects 640 such as T₁, T₂, T₃, . . . , Tₙ to a maintenance target object by using a function of a component object included in a maintenance object in each object or a function of neighboring objects. The maintenance supporting server 120 may detect an approach area of the image frame and record a change in approach state.

FIG. 6B is an example diagram provided to explain a process of extracting pixels of a component object and clustering the pixels into similar pixel groups in accordance with various embodiments described herein. Referring to FIG. 6B, the maintenance supporting server 120 may extract pixels 650 of the recognized component object and cluster the extracted pixels 650 into similar pixel groups 660. In this case, the maintenance supporting server 120 may use the k-means method to cluster the pixels 650 into the similar pixel groups 660.

The k-means method can segment n (component object) number of objects into k (maintenance target object) number of clusters when predicting a subsequent action for sequential events in a hololens image. The similarity of clusters can be derived by measuring a mean value of objects as the centers of gravity in the respective clusters and makes it become suitable for application to hololens environment or a head-mounted display (HMD) device.

According to the K-means method, a conditional probability of a following effect is as follows. In a first process, the number k of clusters is determined and an initial value or a cluster centroid is allocated to each cluster. In a second process, all the data are assigned to the nearest cluster centroid by using a Euclidean distance. In a third process, a new cluster centroid is calculated to minimize a distance between data assigned to each cluster and the new cluster centroid. In a fourth process, the second process and the third process are repeated until there is little change in cluster centroid.

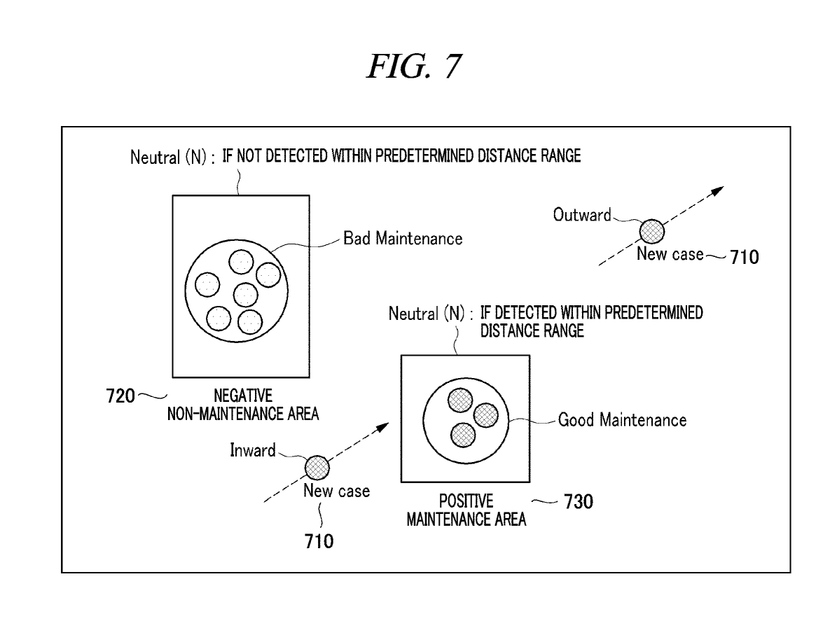

FIG. 7 is an example diagram provided to explain a process of determining a maintenance target object by applying information about distances between a recognized component object and respective maintenance objects to a case-based inference algorithm in accordance with various embodiments described herein.

Referring to FIG. 7, the maintenance supporting server 120 may detect multiple maintenance objects (objects in 720 and objects in 730) from an image and recognize at least one component object 710 (being moved by the maintenance mechanic) corresponding to at least one of the detected multiple maintenance objects (objects in 720 and objects in 730). The maintenance supporting server 120 may recognize the multiple maintenance objects (objects in 720 and objects in 730) as a positive maintenance area or a negative maintenance area by using modeling data, determine whether or not to allow a maintenance object which the component object approaches to be maintained based on the recognized positive maintenance area or negative maintenance area, and notify of the result of determination.

For example, if the component object 710 approaches a first maintenance object (an object in 720) recognized as a negative maintenance area, the maintenance supporting server 120 may transmit, to the wearable device 110, a message to notify that maintenance of the first maintenance object (the object in 720) is not allowed.

For another example, if the component object 710 approaches a second maintenance object (an object in 730) recognized as a positive maintenance area, the maintenance supporting server 120 may transmit, to the wearable device 110, a message to notify that maintenance of the second maintenance object (the object in 730) is allowed.

As such, the maintenance supporting server 120 records relative mobile characteristics of a maintenance object, and, thus, when an event occurs, the maintenance supporting server 120 can provide a probability-based service according to the mobile characteristics of maintenance objects each having mobility based on probability information acquired from a mathematical model.

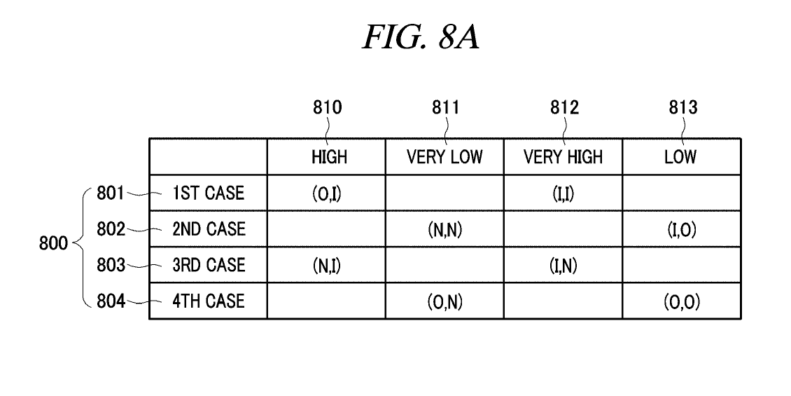

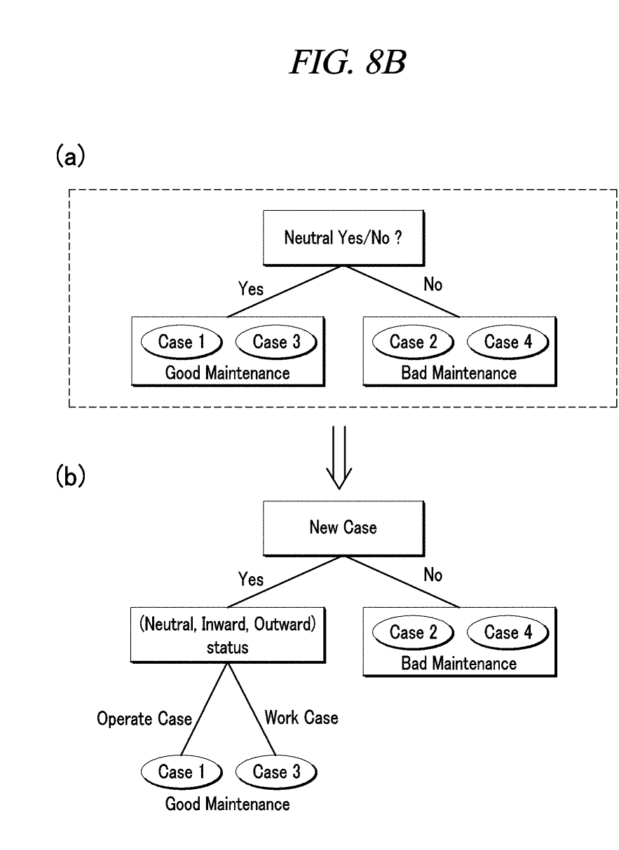

FIG. 8A and FIG. 8B are example diagrams provided to explain a process of determining a maintenance target object based on a case classification tree created on the basis of information about distances between a component object and respective maintenance objects and a similarity table in accordance with various embodiments described herein.

FIG. 8A is an example diagram illustrating a similarity table in accordance with various embodiments described herein and can be used to deduce a proposition of a maintenance process by an inductive method for establishing general propositions from individual observations, i.e., inferring principles from particular facts.

Referring to FIG. 8A, the maintenance supporting server 120 may create a similarity table by classifying cases for finding characteristics and results of characteristic values in the maintenance history. The similarity table may be configured including the possibility of maintenance for each case 800 as high 810, very low 811, very high 812, or low 813.

For example, the maintenance supporting server 120 may classify a case with a high possibility of maintenance (Outward, Inward) or with a very high possibility of maintenance (Inward, Inward) as a first case 801, a case with a very low possibility of maintenance (Neutral, Neutral) or with a low possibility of maintenance (Inward, Outward) as a second case 802, a case with a high possibility of maintenance (Neutral, Inward) or a very high possibility of maintenance (Inward, Neutral) as a third case 803, and a case with a very low possibility of maintenance (Outward, Neutral) or with a low possibility of maintenance (Outward, Outward) as a fourth case 804.

That is, the maintenance supporting server 120 may classify the eight approach states into the four cases each including a pair of an approach state at the preceding point in time and an approach state at the current point in time.

FIG. 8B is an example diagram illustrating a case classification tree in accordance with various embodiments described herein. The case classification tree includes nodes with items to be compared to classify or determine an inference proposition by an inductive method and branches with selectable results or conditions and thus increase the approach effectivity in exploration to increase the operation speed and makes it possible to quickly locate and approach specific data among lots of data.

FIG. 8B(A) shows a determination of a maintenance case by applying a binary search tree that determines the order to quickly search operations of the classified and determined maintenance case. For example, a case in a node tree on the left of a parent tree is composed of values included in a maintenance area of the parent node and a case in a node tree on the right of the parent node is composed of values included in the outside of the normal maintenance area on the assumption that all the data in the tree should be different from each other.

FIG. 8B(B) shows a normal determination of the determined maintenance case which is highly useful because it is possible to greatly reduce time compared to investigation of the entire maintenance area.

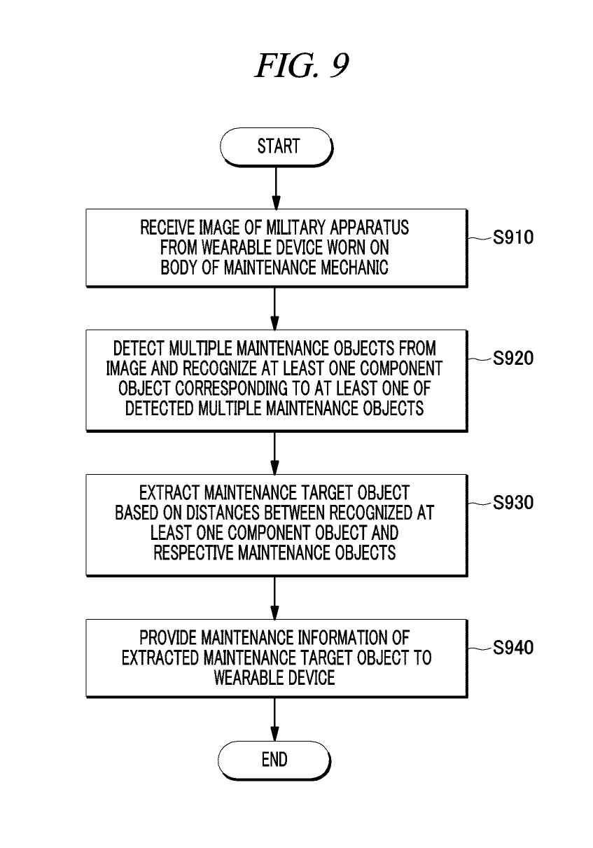

FIG. 9 is a flowchart showing a method for supporting the maintenance of a military apparatus by a maintenance supporting server in accordance with various embodiments described herein. A method for supporting the maintenance of the military apparatus 100 by the maintenance supporting server 120 illustrated in FIG. 9 includes the processes time-sequentially performed by the system 1 for supporting the maintenance of a military apparatus according to the embodiment illustrated in FIG. 1 to FIG. 8. Therefore, descriptions of the processes performed by the system 1 for supporting the maintenance of a military apparatus may be applied to the method for supporting the maintenance of the military apparatus 100 by the maintenance supporting server 120 according to the embodiment illustrated in FIG. 1 to FIG. 8, even though they are omitted hereinafter.

In a process 5910, the maintenance supporting server 120 may receive an image of the military apparatus 100 from the wearable device 110 worn on the body of the maintenance mechanic.

In a process 5920, the maintenance supporting server 120 may detect multiple maintenance objects from the image and recognize at least one component object corresponding to at least one of the detected multiple maintenance objects.

In a process 5930, the maintenance supporting server 120 may extract a maintenance target object based on distances between the recognized at least one component object and the respective maintenance objects.

In a process 5940, the maintenance supporting server 120 may provide maintenance information of the extracted maintenance target object to the wearable device 110.

In the descriptions above, the processes 5910 to 5940 may be divided into additional processes or combined into fewer processes depending on an embodiment. In addition, some of the processes may be omitted and the sequence of the processes may be changed if necessary.

The method for receiving the maintenance support for a military apparatus by a wearable device and the method for providing the maintenance support for a military apparatus by a maintenance supporting server illustrated in FIG. 1 to FIG. 9 can be implemented in a computer program stored in a medium to be executed by a computer or a storage medium including instructions codes executable by a computer. Further, the method for receiving the maintenance support for a military apparatus by a wearable device and the method for providing the maintenance support for a military apparatus by a maintenance supporting server illustrated in FIG. 1 to FIG. 9 can be implemented in a computer program stored in a medium to be executed by a computer

A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A maintenance supporting server that supports the maintenance of a military apparatus, comprising:
an image receiving unit that receives an image of a military apparatus from a wearable device worn on the body of a maintenance mechanic;
an object recognition unit that detects multiple maintenance objects from the image and recognizes at least one component object corresponding to at least one of the detected multiple maintenance objects;
a maintenance target object extraction unit that extracts a maintenance target object based on distances between the recognized at least one component object and the respective maintenance objects; and
a transmission unit that transmits maintenance information of the extracted maintenance target object to the wearable device.

2. The maintenance supporting server of claim 1, further comprising:
a distance measurement unit that measures distances between the recognized at least one component object and the respective maintenance objects,
wherein the distance measurement unit determines, from the image, an approach state of the at least one component object being moved by the maintenance mechanic to each of the maintenance objects from the image.

3. The maintenance supporting server of claim 2,
wherein the maintenance target object extraction unit extracts a maintenance object which the at least one component object is approaching as the maintenance target object, and
the object recognition unit recognizes at least one component object included in the maintenance target object and extracts a location of the recognized component object.

4. The maintenance supporting server of claim 3, further comprising:
an image segmentation unit that segments a frame of the image into multiple cells,
wherein the object recognition unit detects an edge of the at least one component object by applying the extracted location of the at least one component object to a cell of the frame of the image.

5. The maintenance supporting server of claim 1, further comprising:
a pixel extraction unit that extracts pixels from the recognized at least one component object,
wherein the pixel extraction unit clusters the extracted at least one pixel into similar pixel groups.

6. The maintenance supporting server of claim 5,
wherein the maintenance target object extraction unit extracts the clustered similar pixel groups as multiple candidate maintenance areas and extracts a maintenance area including the maintenance target object from among the extracted multiple candidate maintenance areas by using the distances between the at least one component object and the respective maintenance target objects.

7. The maintenance supporting server of claim 1,
wherein the transmission unit provides the maintenance information in the form of augmented reality, virtual reality, or mixed reality to the wearable device.

8. The maintenance supporting server of claim 7,
wherein the maintenance information includes at least one of maintenance details of the maintenance target object, maintenance guide information for the maintenance target object, and a list of component objects used for the maintenance of maintenance target objects.

9. The maintenance supporting server of claim 2,
wherein the maintenance target object extraction unit extracts the maintenance target object based on an approach state of the at least one component object to each of the maintenance objects during a first unit time and an approach state of the at least one component object to each of the maintenance objects during a second unit time after the first unit time.

10. The maintenance supporting server of claim 9,
wherein the maintenance target object extraction unit classifies each maintenance object as a first maintenance area or a second maintenance area based on the approach state of the at least one component object to each of the maintenance objects during the first unit time and the approach state of the at least one component object to each of the maintenance objects during the second unit time after the first unit time and extracts a maintenance object corresponding to the first maintenance area as the maintenance target object, and
the first maintenance area includes a maintenance object to which maintenance is to be performed, and
the second maintenance area includes a maintenance object to which maintenance is not to be performed.

11. The maintenance supporting server of claim 1,
wherein the maintenance target object extraction unit determines at least one maintenance target object from among the multiple maintenance objects detected by applying information about the distances between the recognized at least one component object and the respective maintenance objects to a case-based inference algorithm.

12. The maintenance supporting server of claim 11,
wherein the case-based inference algorithm includes a similarity table based on an approach state between a component object and a maintenance object, and
the maintenance target object extraction unit creates a case classification tree based on the information about the distances between the recognized at least one component object and the respective maintenance objects and the similarity table and determines the at least one maintenance target object based on the created case classification tree.

13. The maintenance supporting server of claim 1, further comprising:
a database that includes information relevant to the maintenance of the military apparatus, maintenance history information, similarity information between maintenance-related tasks and detailed work items, and feedback information of a determined maintenance target object input by the maintenance mechanic.

14. A method for supporting maintenance by a server, comprising:
receiving an image of a military apparatus from a wearable device worn on the body of a maintenance mechanic;
detecting multiple maintenance objects from the image and recognizing at least one component object corresponding to at least one of the detected multiple maintenance objects;
extracting a maintenance target object based on distances between the recognized at least one component object and the respective maintenance objects; and
providing maintenance information of the extracted maintenance target object to the wearable device.

15. A wearable device that receives the maintenance support for a military apparatus, comprising:
a photographing unit that photographs a military apparatus with a camera provided in the wearable device;
a transmission unit that transmits a photographed image of the military apparatus to a maintenance supporting server;
a receiving unit that receives maintenance information of a maintenance target object of the military apparatus from the maintenance supporting server; and
a display unit that displays the received maintenance information of the maintenance target object on a display,
wherein the maintenance supporting server detects multiple maintenance objects from the image and recognizes at least one component object corresponding to at least one of the detected multiple maintenance objects, and
the maintenance target object is extracted based on distances between the recognized at least one component object and the respective maintenance objects.

16. The wearable device of claim 15,
wherein the receiving unit receives the maintenance information in the form of augmented reality, virtual reality, or mixed reality from the maintenance supporting server.

17. The wearable device of claim 15,
wherein the maintenance information includes at least one of maintenance details of the maintenance target object, maintenance guide information for the maintenance target object, and a list of component objects used for the maintenance of maintenance target objects.
